(19) United States
(12) Patent Application Publication
(10) Pub. No.: US 2005/0089045 A1
(43) Pub. Date: Apr. 28, 2005

(54) Method of providing priority-based discriminated services in wireless LAN environment

(75) Inventors: Seung-seop Shim, Anyang-si (KR); Kyung-ik Cho, Suwon-si (KR); Suk-jin Yun, Seoul (KR); Se-young Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/962,451

(22) Filed: Oct. 13, 2004

(30) Foreign Application Priority Data
Oct. 28, 2003 (KR) 10-2003-0075643

(51) Int. Cl. H04L 12/28

(52) U.S. Cl. 370/395.42

(57) ABSTRACT

A method of providing priority-based discriminated services in a wireless LAN environment. More particularly, providing discriminated services while maintaining compatibility with existing 802.11 MAC through a priority index map configured to enable discriminated services. A method of providing priority-based discriminated services in a wireless LAN environment consistent with the present invention includes determining priority ranks for terminals in the wireless LAN environment; and determining backoff times based on the determined priority ranks, and attempting to occupy a channel by sending frames according to the determined backoff times if predetermined channel occupation latency elapses after the transmission of a last frame is completed.

### BACKGROUND OF THE INVENTION

This application claims the priority of Korean Patent Application No. 10-2003-0075643 filed on Oct. 28, 2003 in the Korean Intellectual Property Office, the disclosure of which is incorporated herein in its entirety by reference.

1. Field of the Invention

The present invention relates to a method of providing priority-based discriminated services in a wireless local area network (LAN) environment. More particularly, the present invention enables efficient channel occupation by giving priority for channel occupation to a wireless terminal (hereinafter, simply referred to as “terminal”) that provides a service requiring high bandwidth and real-time features in a wireless LAN environment.

2. Description of the Related Art

Recently, as wireless LAN technology has emerged as a core technology for digital home appliances and mobile communications, research has been widely conducted on standards for constructing new networks in which home appliances and computers are interconnected in a wireless manner and connecting various wireless networks.

Among researched standards, 802.11 Media Access Control (MAC) is a standard for a broadband wireless local area network (WLAN). A main feature of WLAN is directed to a mechanism for how to share channels that are media of wireless communications among wireless terminals.

Such 802.11 MAC defines a polling type point coordination function (hereinafter, referred to as “PCF”), a contention type distributed coordination function (hereinafter, referred to as “DCF”), and a function in which PCF and DCF are combined, according to medium-sharing methods.

Furthermore, 802.11 MAC can be mainly implemented through infrastructure networks or ad-hoc networks depending on the type of WLAN. 802.11 MAC is implemented to secure fairness and provide resources for wireless communications.

In IEEE 802.11 MAC, a basic access method, is the DCF method of providing contention-based services. DCF is operated according to a timing relationship defined by IEEE 802.11 working group (ANSI/IEEE Std 802.11 First Edition 1999), as shown in FIG. 1a.

Such DCF employs DCF InterFrame Space (DIFS) as a criterion for determining whether a channel is used based on a minimum channel idle time and also employs an arbitrary backoff time to avoid conflict when the channel is accessed.

In other words, after the transmission of a last frame is completed, terminals are not allowed to immediately access the channel after the wait during DIFS but generate random backoff times and are then suspended to access the channel during the random backoff times. This reduces a possibility of conflict among terminals that are trying to access the channel immediately after the transmission of the last frame.

The random backoff time is generated by means of a predetermined backoff algorithm. A typical backoff algorithm is a binary exponential backoff algorithm.

In the binary exponential backoff algorithm, if conflict occurs in contention, a backoff time Tb is doubled to minimize conflict and expressed as the following formula 1.
Tb=└2²⁺ⁱ×R( )┘×St=(2ⁿ−1)×St (1)
where Tb: Backoff time,
R( ): An integer value having uniform distribution in a range from 0 to a contention window (CW),
St: aSlotTime,
n=occurrence of collision, and
i=Initial value 1.

In formula 1, as the backoff time value is increased in re-contention after conflict occurs, the size of CW is also increased by multiples, as shown in FIG. 1b.

In such 802.11 MAC described above, terminals determine whether a channel is used during the same DIFS according to fairness, and perform contention for channel occupation by using a random backoff time generated through the same backoff algorithm, so that they can use the channel according to equally distributed chances.

In this case, however, a terminal that requires a real-time data streaming service should perform the same contention with other terminals according to fairness. Thus, there is a problem in that a case where a terminal is hindered due to the occupation of a channel by other terminals during a service-providing process may happen.

In particular, in a special ad-hoc environment such as home networks that are widely constructed in homes where wired connections are not supported, it results in deterioration of the expected performance of a system due to the fairness in 802.11 MAC.

As an example, if a home network server with a broadcast signal receiver embedded therein serves as both a gateway and a streaming server for transferring a received broadcast signal to a TV, the home network server should fairly contend with stations that are trying to send common information technology (IT) (e.g., Internet) data under every condition where the received broadcast signal is sent to the TV that is a client terminal. As a result, this server has difficulty in occupying a channel.

For this reason, it is difficult for such a server to support real-time features and the use of high bandwidth that are required in broadcast signal transmission services. Thus, there is a problem in that the server may damage a streaming transmission process that requires the real-time features and the high bandwidth.

Therefore, there is a need for a priority-based discriminated service-providing method of providing discriminated services according to priority allocated depending on properties of stations and services in a wireless LAN under an ad-hoc environment that is operated by only DCF while maintaining compatibility with existing 802.11 MAC.

### SUMMARY OF THE INVENTION

The present invention addresses the aforementioned problems. A primary aspect of the present invention is to provide discriminated services while maintaining compatibility with existing 802.11 MAC through a priority index map configured to enable discriminated services.

Another aspect of the present invention is to allow channel occupation of a station that requires real-time features and high bandwidth to be efficiently performed through discriminated services.

Consistent with the present invention, in a wireless LAN environment, each terminal determines a priority rank and a backoff time depending on the priority rank on the basis of a priority index map. When the transmission of a last frame is completed, the terminal waits for a predetermined channel occupation time and then sends a frame according to the determined backoff time to attempt channel occupation. In such a way, discriminated services can be provided according to the backoff time depending on priority.

In the present invention, the priority index map comprises of indices (n) for configuring predetermined priority ranks depending on service properties and backoff times depending on the respective priority ranks, and slot times (ST_sub) that are to be subtracted.

The service properties are classified according to roles and types of data in a wireless LAN environment. The service properties comprise combinations of the roles that are divided into server, client and general terminal, and the types of data that are divided into streaming flow and traffic flow.

Furthermore, in an exemplary embodiment of the present invention, an index map for channel occupation latency and an index map for frame sizes are configured by referring to a priority index map, so that channel occupation latency and frame size can vary according to the priority ranks.

Consistent with an aspect of the present invention, there is provided a method of providing priority-based discriminated services in a wireless LAN environment, comprising determining priority ranks for terminals in the wireless LAN environment; and determining backoff times based on the determined priority ranks, and attempting to occupy a channel by sending frames according to the determined backoff times if predetermined channel occupation latency elapses after the transmission of a last frame is completed.

Furthermore, in the method of providing discriminated services consistent with the present invention, a priority rank is determined based on a priority index map according to the service properties of a terminal. The priority index map is configured such that a higher priority rank has a lower backoff time and a lower priority rank has a higher backoff time.

In addition, in the method of providing discriminated services consistent with the present invention, the channel occupation latency and frame size are differently set according to the priority rank.

### BRIEF DESCRIPTION OF THE DRAWINGS

The above and other aspects, features and advantages of the present invention will become apparent from the following description of exemplary embodiments given in conjunction with the accompanying drawings, in which:

FIGS. 1a and 1b are schematic diagrams illustrating a general standard for a wireless LAN;

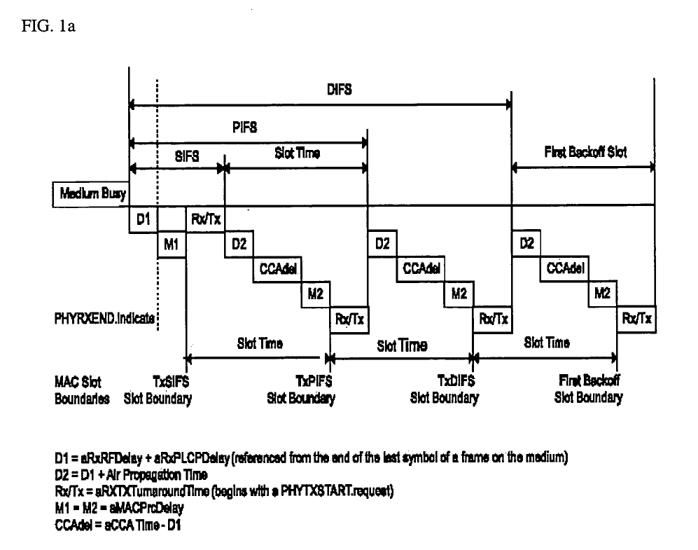

FIG. 2 schematically shows the configuration of a home network wireless LAN in an ad-hoc environment consistent with an embodiment of the present invention;

FIG. 3 shows a priority index map consistent with an embodiment of the present invention;

FIG. 4 shows an index map for channel occupation latency consistent with an embodiment of the present invention;

FIG. 5 schematically shows a frame format consistent with an embodiment of the present invention;

FIG. 6 schematically shows a role table defined for the types and subtypes of control frame fields;

FIG. 7 shows an index map for frame sizes consistent with an embodiment of the present invention;

FIG. 8 schematically shows the process of providing priority-based discriminated services in a home network wireless LAN under an ad-hoc environment consistent with an embodiment of the present invention; and

FIG. 9 schematically shows the process of providing priority-based discriminated services in a home network wireless LAN under an ad-hoc environment consistent with another embodiment of the present invention.

### DETAILED DESCRIPTION OF THE INVENTION

Hereinafter, a method of providing priority-based discriminated services in a wireless LAN environment consistent with the present invention will be described in detail with reference to the accompanying drawings.

In the following description of the method of providing the priority-based discriminated services in the wireless LAN environment consistent with the present invention, it will be described that the method is implemented through priority ranks that are determined according to service properties. However, this is merely illustrative. It can be understood by those skilled in the art that there are various modifications and other embodiments related to a method of increasing a channel occupation ratio of a terminal which provides a relevant service by giving priority to a service according to the developer's or user's selection as well as service properties.

Furthermore, in the following description of the method of providing priority-based discriminated services in a wireless LAN environment consistent with the present invention, it will be described that the method is implemented in a wireless LAN under an ad-hoc environment that operates through only DCF. However, this is also merely illustrative. It can also be understood by those skilled in the art that there are various modifications and other equivalent embodiments related to a method of increasing the channel occupation ratio of a terminal which provides a relevant service by giving priority to the service in a wireless LAN environment that operates through only DCF and a combination of DCF and PCF.

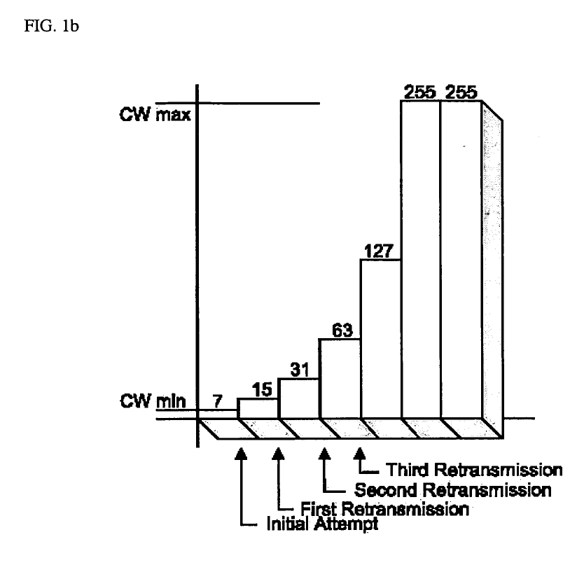

FIG. 2 schematically shows the configuration of an ad hoc network in a wireless LAN environment consistent with an embodiment of the present invention.

As shown in FIG. 2, the ad hoc network (e.g., home network) in the wireless LAN environment comprises a plurality of terminals 101, 102, . . . , 10n that communicate with one another through channels as wireless interfaces in a wireless LAN environment with no communication infrastructure.

The plurality of the terminals 101, 102, . . . , 10n determine their priority ranks by referring to a priority index map, and attempt channel occupation after predetermined channel occupation latency if they intend to transmit given frames after the transmission of a last frame is completed.

In other words, the terminals 101, 102, . . . , 10n determine their priority ranks and backoff times according to the properties of services that will be provided via channels, by referring to the priority index map.

Then, after the predetermined channel occupation latency, the terminals send frames according to their determined backoff times.

At this time, a terminal that provides a service having a high priority rank in view of the backoff time determined according to the priority rank wins contention and occupies a channel.

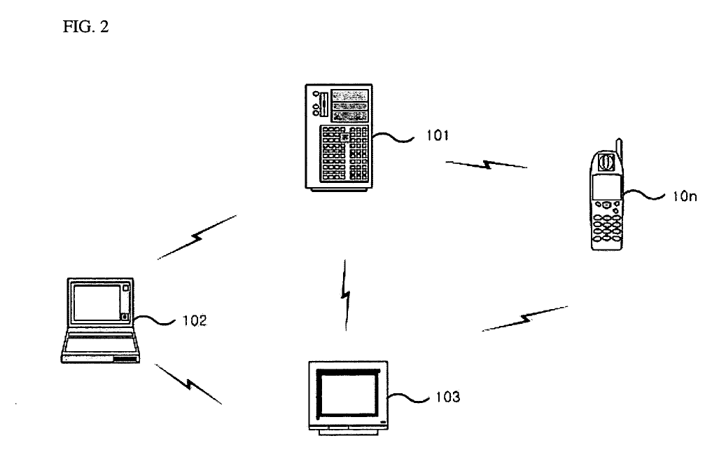

FIG. 3 shows a priority index map consistent with an embodiment of the present invention.

As shown in FIG. 3, the priority index map comprises indices (a) indicating predetermined priority ranks depending on service properties, the service properties (b) depending on the priority ranks, and configuration information for use in configuring backoff times according to the priority ranks.

The configuration information consists of indices n(c) for determining the backoff times and slot times ST_sub(d) that are to be subtracted.

The indices (a) indicating the priority ranks are obtained by classifying priority into predetermined ranks. For example, the indices are configured such that the priority ranks are classified into P1 to P7 and the priority becomes lower as the rank becomes higher.

Furthermore, consistent with the present invention, a priority rank P8 is configured for a conventional terminal with no priority rank, in order to maintain compatibility with existing 802.11 MAC. The index (c) for controlling the backoff time and the slot time (d) for subtraction are set to, for example, 3 and 1, respectively.

The service properties (b) comprise combinations of roles and the types of data that determine the properties of services in a wireless LAN environment.

The roles in the wireless LAN environment are classified into a server (server wireless terminal “sWT”) connected to an external network via a predetermined interface to perform the operation of a server/gateway and receive data for a specific purpose, a client (client wireless terminal “cWT”) connected to sWT via a wireless interface to receive data for a specific purpose through a streaming service from sWT, and a terminal (Internet/intranetworking wireless terminal “iWT”) having only general Internet/intranetworking traffic.

The types of data are classified into data fDATA having streaming flow properties, and data tDATA having general networking traffic flow properties.

The index n(c) and the slot time ST_sub(d) that is to be subtracted are to increase the channel occupation ratio of a terminal that provides a service with a high priority rank. They are adjusted such that a higher priority rank has a lower backoff time and a lower priority rank has a higher backoff time.

In other words, the index n(c) and the slot time ST_sub(d) are obtained through formula 1 that calculates a backoff time described above. The index n(c) controls the amount of backoff time and the slot time ST_sub(d) for subtraction is a number that is subtracted to reduce a backoff time.

That is, if a priority rank is high, the index n is decreased so that a small backoff time is calculated through formula 1. In order to further decrease the resultant reduced backoff time, the slot time ST_sub is increased and then subtracted.

As the backoff time is decreased through this process, the channel occupation ratio increases upon contention.

The decrease in the backoff time through the subtraction of the slot time, ST_sub therefrom is made only when conflict does not occur upon contention.

Furthermore, if the priority rank is low, the slot time ST_sub is decreased and then subtracted to further lower the channel occupation ratio of the backoff time through formula 1.

If the remaining slot time ST_re which will be subjected to subtraction is smaller than the slot time ST_sub that will be subtracted therefrom, and thus, becomes a negative value after subtraction during the calculation of a backoff time using the following formula 2, the process is performed based on the algorithm of formula 2.
If(ST_re<ST_sub)
then ST=0;
else ST_{—}re=ST_{—}re−ST_{—}sub (2)

In other words, for example, if the remaining slot time ST_re that will be subjected to subtraction is smaller than the slot time ST_sub that will be subtracted therefrom during the calculation of a backoff time after frame collision occurs, the slot time is set to 0 so that a terminal can receive a frame transmission chance without being allocated a backoff time.

Furthermore, if the remaining slot time ST_re that will be subjected to subtraction is larger than the slot time ST_sub that will be subtracted therefrom, the resultant value obtained through the subtraction is set to the remaining slot time ST_re.

Therefore, as the remaining slot time ST_re is smaller than a slot time ST_sub that will be subtracted therefrom when the next backoff time is calculated, the slot time is set to 0.

If conflict occurs among terminals having the same backoff time during a contention process according to the calculated backoff time, the conflict is processed based on the algorithm of the following formula 3.
If(WTx(Pι)>WTy(Pι))
then ST_x=0;
else ST_y=0 (3)

In other words, for example, if priority Pι of wireless terminal WTx is higher than priority Pι of wireless terminal Wty, the slot time ST_x of terminal WTx is set to 0, so that terminal WTx has higher priority. Otherwise, the slot time ST_y of terminal Wty is set to 0, so that terminal Wty has higher priority.

Through this process, the indices (a) of the priority ranks are created in the priority index map on the basis of a service that requires real-time features and high bandwidth, in order to configure a combination of the role of a terminal corresponding to each rank and the service type (b), the index (c) for controlling a backoff time, and the slot time number (d) for subtraction.

For example, if the range of the index n is set to 0 to 3 and the range of the slot number ST_sub for subtraction is set to 1 to 6, the index n is set to 0 and the slot time is set to 6 so as to calculate a low backoff time in the highest priority rank, and the index n is set to 3 and the slot time is set to 1 so as to calculate a high backoff time in the lowest priority rank.

A high channel occupation ratio of a terminal that provides a service having a high priority rank is secured through a backoff time depending on the priority rank as described above. Consistent with another embodiment of the present invention, priority is allocated through a backoff time depending on the priority rank and the existing channel occupation latency is caused to vary according to the priority, thereby more firmly securing a high channel occupation ratio of a terminal that provides a service having a high priority rank through channel occupation latency.

To this end, each terminal has a priority index map, and an index map for channel occupation latency that represents channel occupation latency for each priority rank of the priority index map.

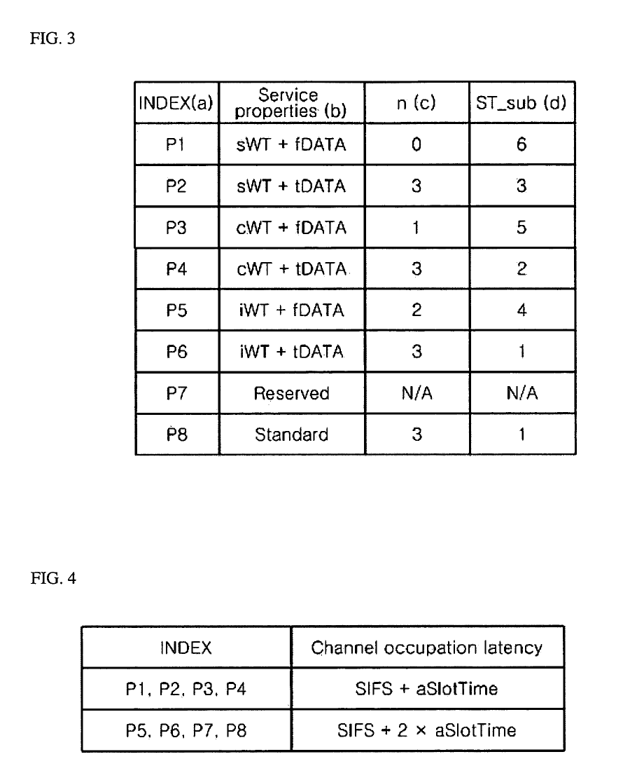

FIG. 4 shows an index map for channel occupation latency consistent with an embodiment of the present invention.

As shown in FIG. 4, the index map for channel occupation latency differently configures channel occupation latency according to priority, such that higher priority has shorter channel occupation latency and lower priority has longer channel occupation latency.

The shorter channel occupation latency is SIFS+aSlotTime and the longer channel occupation latency is SIFS+2×aSlotTime.

For example, it is assumed that priority ranks P1, P2, P3 and P4 have shorter channel occupation latency and priority ranks P5, P6, P7 and P8 have longer channel occupation latency in the index (a) of the priority index map. In this case, if the priority ranks P1 and P5 send frames for channel occupation after the transmission of the last frame, the priority rank P1 determines whether a channel is idle during SIFS+aSlotTime and sends the frame according to its backoff time.

Furthermore, the priority rank P5 determines whether the channel is idle during SIFS+2×aSlotTime and then sends the frame according to its backoff time.

As a result, the channel is occupied by the frame sent from the priority rank P1 rather than the frame sent from the priority rank P5 according to channel occupation latency depending on their priority ranks.

In such a way, since channel occupation latency is differently set depending on the priority ranks, a frame sent from a higher priority rank always occupies the channel.

A channel occupation ratio of a terminal that provides a service having a higher priority rank is secured through channel occupation latency and backoff time depending on the priority ranks. Consistent with a further embodiment of the present invention, the existing frame size is changed according to priority to more firmly secure a channel occupation ratio of a terminal that provides a service having a high priority rank through frame size.

To this end, each terminal has a priority index map, an index map for channel occupation latency, and an index map for a frame size that represents the frame size for each priority rank of the priority index map.

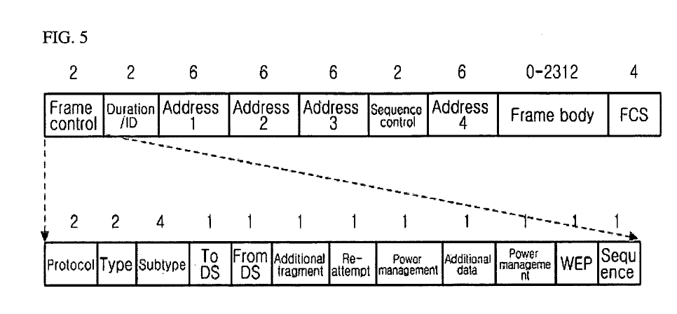

FIG. 5 schematically shows a frame format consistent with an embodiment of the present invention.

As shown in FIG. 5, the frame format is constructed in the same manner as an existing standard frame format. The frame format comprises a frame control field of 2 bytes, a duration/ID field of 2 bytes, an address field (address 1, address 2, address 3) of 18 bytes, a sequence control field of 2 bytes, an address field (address 4) of 6 bytes, a frame body field of maximum 2,312 bytes, and a frame check sequence (FCS) field of 4 bytes.

The frame control field comprises a protocol field in which a protocol version such as 802.11 MAC is written, type and subtype fields enabling discrimination of the type of a field that is being used, a To Distribution System (ToDS) field for storing various parameters for the control of the frame, a From Distribution System (FromDS) field, an additional fragment field, a re-attempt field, a power management field, an additional data field, another power management field, a Wired Equivalent Privacy (WEP) field, a sequence field, and the like.

The duration/ID field is used for various purposes and is used as any one of a frame that is transmitted during duration (network allocation vector (NAV)) configuration, a contention-free period (CFP) and a PS-Poll frame.

The address field stores parameters for movement of the frame. The field for address 1 is used for a receiver, the field for address 2 is used for a transmitter, and the field for address 3 is used for filtering by the receiver.

The sequence control field is used for fragmentation, reassembly and discard of a redundant frame. This field consists of a fragmentation number field of 4 bits and a sequence number field of 12 bits.

The frame body field is called a data field and supports a frame body of 2,312 bytes to contain overhead (8 bytes) by Wired Equivalent Privacy (WEP) that can send data of maximum 2,304 bytes.

The FCS field is used to check the integrity of a frame received from a specific terminal.

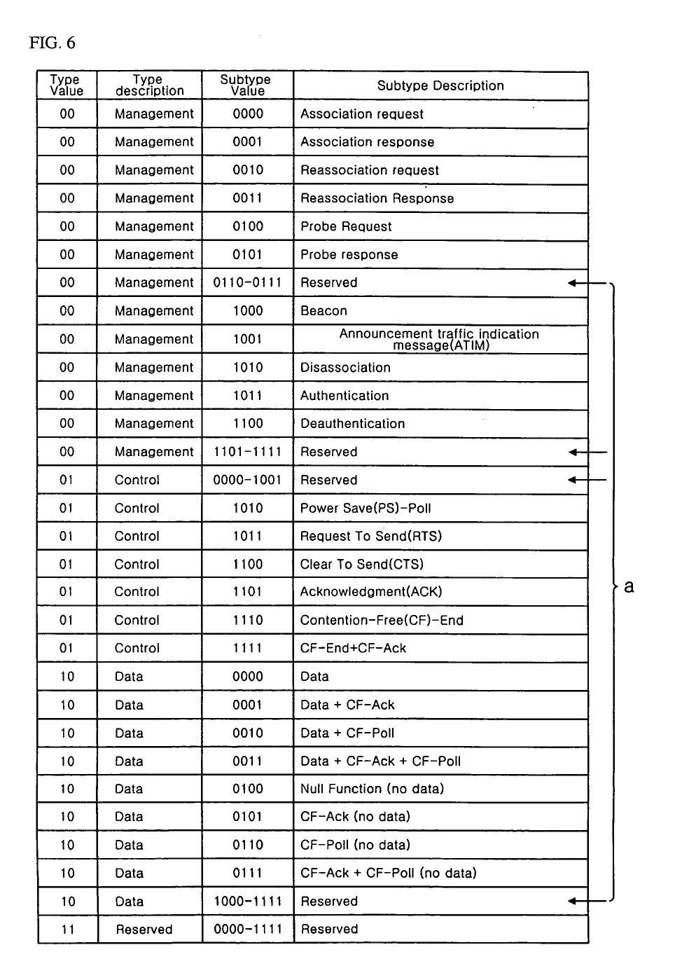

FIG. 6 schematically shows a role table defined for the types and subtypes of control frame fields.

As shown in FIG. 6, the types of control frames are classified into management, control and data. The subtypes are classified into predetermined operations depending on the respective types.

These types and subtypes are set as predetermined identification bits, so that a receiving terminal can confirm the type of frame received based on the type and subtype of the frame.

The present invention configures frames having different frame sizes depending on priority ranks by using bit set values (Reserved bits which are indicated by ‘a’) which are not used in the identification bits of the type and subtype.

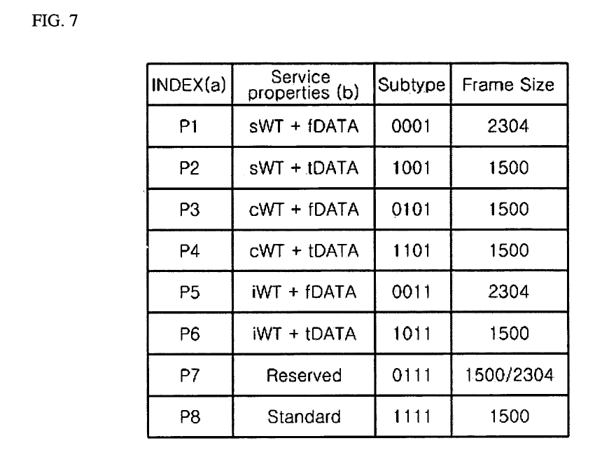

FIG. 7 shows an index map for frame sizes consistent with an embodiment of the present invention.

As shown in FIG. 7, the index map for frame sizes consistent with the present invention causes predetermined identification bit values (a), which are not used in the type and subtype bit sets, to be configured into frames of which the sizes vary.

If high bandwidth is required according to the data service type of a service, the frame size is set to 2,304 bytes that is the maximum frame size. If a high bandwidth is not required, the frame size is set to 1,500 bytes that is a general frame size.

For example, when a service of which the priority rank is P1 is performed, sWT determines whether a channel is idle based on channel occupation latency and then sends a frame with a size of 2,304 bytes after a predetermined backoff time elapses.

In this case, sWT always has a high channel occupation ratio due to the channel occupation latency and the backoff time depending on the priority rank P1 and can send a great deal of data through a frame with a changed size.

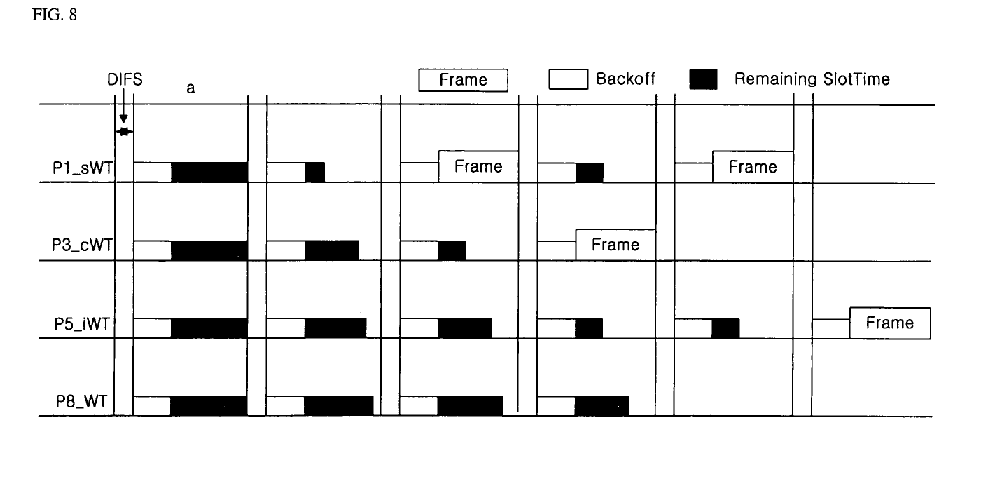

FIG. 8 schematically shows the process of providing priority-based discriminated services in a home network wireless LAN under an ad-hoc environment consistent with an embodiment of the present invention.

As shown in FIG. 8, if all terminals have the same backoff time and remaining slot time (ST_re) at one moment in the home network wireless LAN under the ad-hoc environment in which sWT (P1_sWT) of which the priority rank is P1, cWT (P3_cWT) of which the priority rank is P3 and iWT (P5_iWT) of which the priority rank is P5 exist (as designated by a in the figure), each of the terminals generates a backoff time for re-contention.

At this time, each terminal calculates the backoff time based on an index n corresponding to each terminal and a slot time ST_sub for subtraction, which are obtained through a priority index map.

In this case, since the index n is increased and the slot time ST_sub is decreased as priority is lowered, P1_sWT having the highest priority preferentially occupies a channel due to a lower backoff time according to its priority.

Thereafter, if the transmission of frames by P1_sWT that has occupied the channel is completed, P3_cWT has a smaller contention window and a larger slot time (ST_sub) during the process of calculating a backoff time upon re-contention. Accordingly, P3_cWT occupies the channel.

In such a way, when the terminals contend with one another to occupy the channel, terminals of higher priority ranks can continue to occupy the channel according to the backoff times depending on the priority ranks of the respective terminals.

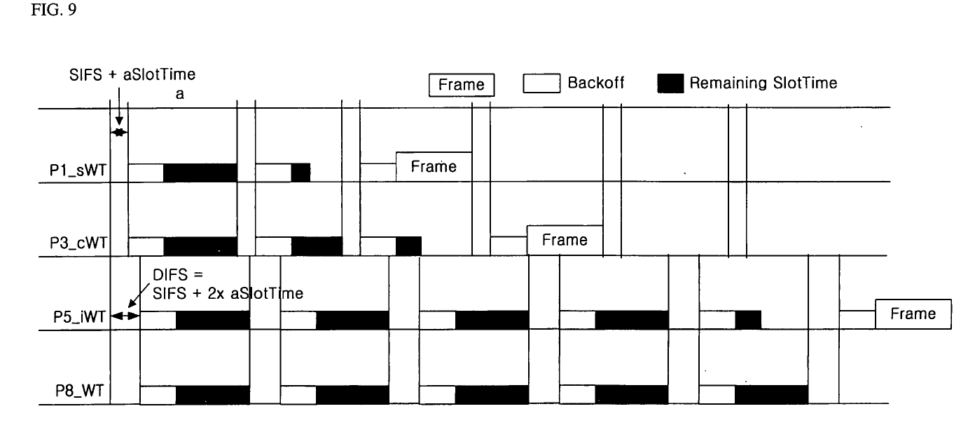

FIG. 9 schematically shows the process of providing priority-based discriminated services in a home network wireless LAN under an ad-hoc environment consistent with another embodiment of the present invention.

As shown in FIG. 9, if all terminals have the same backoff time and remaining slot time (ST_re) at one moment in the home network wireless LAN under the ad-hoc environment in which sWT (P1_sWT) of which the priority rank is P1, cWT (P3_cWT) of which the priority rank is P3 and iWT (P5_iWT) of which the priority rank is P5 exist (as designated by a in the figure), each terminal determines whether a channel is idle based on predetermined channel occupation latency.

In this process, each terminal determines whether the channel is idle based on the channel occupation latency corresponding to each terminal that is obtained through an index map for channel occupation latency, and then sends a frame after a backoff time elapses.

In this case, since a terminal having a higher priority has shorter channel occupation latency, P5_iWT having a lower priority rank cannot occupy the channel while P1_sWT and P3_cWT having higher priority ranks are attempting to occupy the channel.

As described above, consistent with the present invention, it is possible to provide discriminated services while maintaining compatibility with existing 802.11 MAC through a priority index map configured to enable the discriminated services.

Furthermore, the present invention has an advantage in that channel occupation of a terminal that provides a service that requires real-time features and high bandwidth can be efficiently performed through discriminated services.

Although the present invention has been described in connection with the embodiments of the present invention illustrated in the accompanying drawings, the embodiments are merely illustrative. It can be understood by those skilled in the art that various modifications and other equivalent embodiments can be made without departing from the scope and spirit of the invention.

Therefore, the true technical scope of the present invention should be defined by the appended claims.

1. A method of providing priority-based discriminated services in a wireless LAN environment, comprising:
determining priority ranks for terminals in the wireless local area network (LAN) environment; and
determining backoff times based on the determined priority ranks, and attempting to occupy a channel by sending frames according to the determined backoff times if predetermined channel occupation latency elapses after the transmission of a last frame is completed.

2. The method as claimed in claim 1, wherein the priority ranks are determined through a predetermined priority index map according to service properties corresponding to roles in the wireless LAN environment and types of data.

3. The method as claimed in claim 2, wherein the priority index map comprises predetermined priority ranks depending on the service properties, and configuration information for configuring the backoff times depending on the respective priority ranks.

4. The method as claimed in claim 3, wherein the configuration information comprises indices that determine the backoff times and slot times that are to be subtracted, the indices are used to control the amounts of the backoff times, and the slot times are numbers that are subtracted to decrease the backoff times.

5. The method as claimed in claim 3, wherein the priority index map is configured such that a higher priority rank has a lower backoff time.

6. The method as claimed in claim 3, wherein the priority index map is configured such that a lower priority rank has a higher backoff time.

7. The method as claimed in claim 1, wherein the channel occupation latency is differently set according to the priority ranks.

8. The method as claimed in claim 7, wherein if the priority rank is higher, the channel occupation latency is set to be shorter.

9. The method as claimed in claim 8, wherein the shorter channel occupation latency is a short interframe space plus a slot time.

10. The method as claimed in claim 7, wherein if the priority rank is lower, the channel occupation latency is set to be longer.

11. The method as claimed in claim 10, wherein the longer channel occupation latency is a short interframe space plus twice a slot time.

12. The method as claimed in claim 1, wherein the sizes of the frames transmitted are differently set according to the priority ranks.

13. The method as claimed in claim 12, wherein the sizes of the frames are determined through a predetermined index map for frame sizes.

14. The method as claimed in claim 13, wherein the index map for frame sizes comprises frame sizes for the respective priority ranks depending on the service properties, and identification bits for subtype fields of the frames that are allocated to the respective priority ranks.

15. The method as claimed in claim 14, wherein the identification bits are bit set values that are not being used among identification bits for a type and subtype in a frame control field of a standard frame format.
